(19) United States
(12) Patent Application Publication
(10) Pub. No.: US 2010/0009320 A1
(43) Pub. Date: Jan. 14, 2010

(54) CREDIT MANAGEMENT COURSE

(76) Inventor: Christopher Allen Wilkelis, Ferndale, MI (US)

Correspondence Address: MICHAEL RIES, 318 PARKER PLACE, OSWEGO, IL, 60543, US

(21) Appl. No.: 12/501,083

(22) Filed: Jul. 10, 2009

Related U.S. Application Data
(60) Provisional application No. 61/080,007, filed on Jul. 11, 2008.

(51) Int. Cl. G09B 19/18

(52) U.S. Cl. 434/109

(57) ABSTRACT

A method for teaching how a borrower's FICO credit score may increase or decrease as one or more of the categories of information in a credit report is changed. The significance of modifying any one category by a borrower depends on other categories of information in the credit report that makes up the score, and a change in any one category has an effect on an increase or decrease of a credit score. The categories of information are bills; balances; debt; credit history; new credit accounts; credit file; unused credit cards; new credit cards; new accounts; and rate shopping.

### REFERENCE TO RELATED APPLICATION

This patent application claims the benefit of U.S. Provisional Application No. 61/080,007 filed on Jul. 11, 2008, the disclosure of which is incorporated herein by reference in its entirety.

### BACKGROUND OF THE INVENTION

1. Field of the Invention

This invention relates to a credit management course for middle and high school students that will educate and develop an understanding of managing credit and more specifically provides a method for managing a person's accounts in order to achieve a favorable audit report with a desirable FICO score.

2. Description of the Related Art

Recent events have made it desirable for individuals, particularly students to develop an understanding of what is involved in obtaining approval from a lending company for obtaining credit. An important indicator for obtaining credit is a credit score that is known as the FICO score. FICO is a score obtained by using the scoring algorithms developed by Fair, Isaac and Company, Inc. of San Rafael, Calif. (FICO) for providing a metric that indicates how likely it is that a borrower will repay a loan.

A. Flint, D. Lear, C. St. John, Method and Apparatus for Explaining Credit Scores, U.S. patent application Ser. No. 09/790,453 (Feb. 2, 2001) describe a Web site containing an array of informative resources including for-pay services and extranet functions to serve consumers, financial counselors, mortgage brokers, direct lenders, large national credit issuers, etc. The focus of the Flint et al. invention is to educate consumers and others by offering them access to the information that is used when evaluating consumer credit data.

While the Flint et al. invention is a good source for explaining how a consumer credit score is obtained, it would be helpful to provide a method which can be used to help a person elevate his/her FICO credit score.

### SUMMARY OF THE INVENTION

The invention is directed to a method for teaching how a borrower's FICO credit score may increase or decrease as one or more of the categories of information in a credit report is changed. The significance of modifying any one category by a borrower depends on other categories of information in the credit report that makes up the score, and a change in any one category has an effect on an increase or decrease of a credit score. The categories of information are bills; balances; debt; credit history; new credit accounts; credit file; unused credit cards; new credit cards; new accounts; and rate shopping.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings.

FIG. 1 is a flow diagram showing a method for improving a FICO score in accordance with the principles of the invention where a solid line designates a person's activity and a dotted line associated with a specific solid line indicates a possible FICO score change; no dotted line indicates no score change.

### DETAILED DESCRIPTION OF THE INVENTION

When a person goes to a bank for a loan to buy, for example, furniture or applies for a credit card, the Bank will look at the borrowers credit report and FICO score. The FICO score is a number with three digits that indicates whether the borrower can repay the loan. It is obtained by using information in the borrower's credit report which includes, but is not limited to personal information about the borrower such as his/her name, date of birth, address, the type and age of account currently being used, late payments, etc.

There are three major credit-reporting agencies, Equifax, Experian and TransUnion. Each agency uses software developed by Fair Isaac Corp. to generate the FICO score of a borrower. The score from each of the three agencies may be different.

The FICO score is composed of five different categories which are not applied equally about a borrower's credit actives.

The categories and the weight applied for each category are: 35% for the borrower's Payment History. Charges; bankruptcies; late payments; judgments; liens; etc. will drive the score down. However, their effect on the score will diminish with age.

30% for Utilization. Several credit cards where each has a low balance that is due will give a higher score than a few cards with high balances that are near their maximum. One of the fastest ways to increasing a credit score is to keep each credit card at about 10% of its limit.

15% for Established History. The longer a borrower keeps his/her cards active, the higher his/her score will be. A new borrower with no history can benefit by being added as a User to another person's card. The other person should have a card with a long history; a high credit limit; and a low balance with no late payments.

10% for Inquiries. Unnecessary requests for credit reports will cause the FICO score to go down. A borrower should not apply for credit unless he/she knows that it can be obtained or there is a need to get it. When applying for credit, the borrower should get his/her own credit report first because this won't reduce the score. The borrower can show the credit report to a local bank, but not authorize the bank to get a credit report unless they will approve the loan. This prevents unnecessary requests for the credit report.

10% for Closing Credit cards. The borrower should use different types of credit such a revolving, installment, auto, mortgage evenly.

If a borrower consolidates by closing accounts, the borrower should be careful how this is done because it can result in dropping the credit score. This is because the overall available credit limit reduces the balance. Utilization can be hurt by consolidating and closing accounts.

The following information is not included in a borrower's credit report:
The Race, Color. Religion. National Origin; Sex; Marital Status; or Age of a borrower.
The salary, occupation. title. Employer, date employed or employment history of a borrower;
Where a borrower lives; and
Anything that is not in the borrower's credit file:

As noted, the formula used to calculate a borrower's FICO score includes:
the borrower's payment history (35%);
the amount the borrower currently owes to lenders (30%);
the length of the borrowers credit history (15%);
the number of new credit accounts the borrower has opened or applied for (fewer is better) (10%); and
the mix of credit accounts the borrower has (mortgages, credit cards, installment loans, etc.) (10%).

The range of the FICO scores varies between 300 and 850 and is rated. as follows:
Over 750, Excellent
720 or more, Very Good:
660 to 720, Acceptable:
620 to 660, Uncertain:
less than 620, Risky:

While a FICO score can be improved, it can not be done quickly because the score is based on timely payments without lapses.

To obtain and keep a high FICO score a borrower must follow conservative credit procedures.

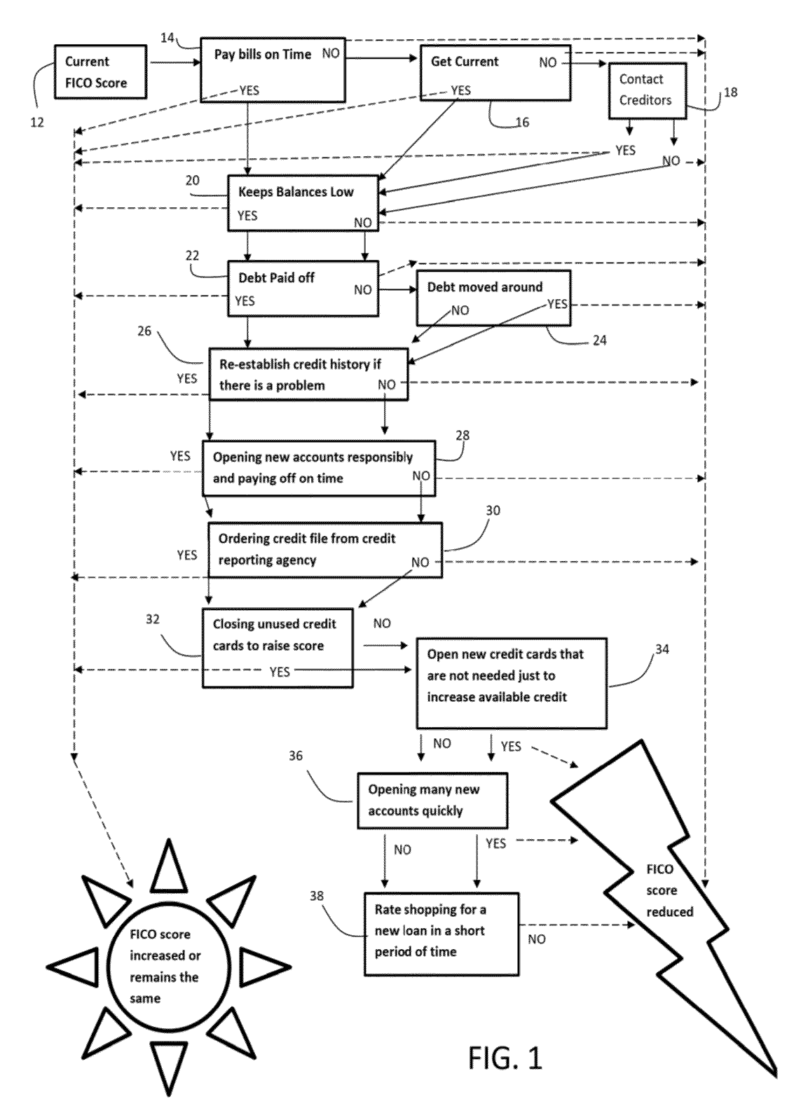

Referring to FIG. 1, there is shown a flow diagram of a method for improving a FICO score where a solid line designates a person's activity and a dotted line associated with a specific solid line indicates a possible FICO score change; no dotted line indicates no score change. A borrower starts with a FICO score, block 12, that has a three digit number. The longer the borrower pays his/her bills on time, the higher the FICO score, YES block 14. Late payments and collections can lower a borrower's score, NO block 14. If a payment has been missed, the borrower should get current, YES block 16, as quickly as possible and stay current. If the borrower is having trouble making payments on time, the creditors should be contacted, block 18. With help the borrower can continue, YES block 18, or in the alternative his/her score will go down, NO block 18.

The borrower should keep his/her balances low, less than 10% on credit cards and other revolving credit, YES block 20, because a high outstanding debt can result in a low score, NO block 20. Efforts by the borrower to pay off debt, YES block 22, will result in a higher score. Moving debt from one credit card to another, block 24, will lower the score. If the borrower experiences problems, his/her credit score can be maintained by re-establishing his/her credit history, YES block 26. Absent a history change can result in a lower score, NO block 26.

Advancing to the next step, applying and opening new credit accounts only as needed and paying them off on time, YES block 28, can result in a higher score, whereas a borrower's score will decrease if the added payments cannot be made in a timely manner, NO block 28. Thereafter, the borrower can request and check his/her own credit file without affecting the score as long as the credit file is obtained directly form the credit reporting agency of through an organization authorized to provide credit files to consumers, YES block 30. Not using an authorized agency will result is a lower score, NO block 30.

In general, someone with no credit cards may be considered to be a higher risk than someone who has managed credit cards responsibly. Therefore, having credit cards and installment loans and making timely payments will raise a borrower's score.

Continuing with the flow diagram, if the borrower does not close an unused credit card, NO block 32. his/her score will not go down Closing an unused card can cause the score to drop. An open account should not be closed unless it is costing money.

Looking at the next step, obtaining a number of new accounts that are not needed just to increase the available credit can actually lower the borrower's score, YES block 34, because the increase in the number of cards can look like an increase risk, particularly if the borrower is a new credit user. In addition, new accounts will lower the average account age which can have a large effect on the score. Not opening the accounts, NO block 34, will have no affect on the score.

Also, opening many new accounts in a short period of time, YES block 36, will reduce the credit score. Not doing so, NO block 36, will not affect the total score. Finally, looking for a new loan within a short time interval, YES block 38, will have a very small negative affect of the score. Looking for the loan over a long period, NO block 38, will lower the score. The FICO score distinguishes between a search for a single loan and a search for many new credit lines by the length of time over which inquiries occur.

A borrower's credit score should be kept as high as possible because it can affect many parts of his/her life. For example: Banks and credit card companies review a person's score when deciding whether to extend credit and how much interest to charge. A high score can lead to lower car and home insurance premiums, a deposit waiver from utility companies, etc. A landlord may check a perspective tenant's credit scores before allowing a lease to be signed. Some employers are doing credit checks on prospective employees, particularly those who work with money.

Clearly, therefore, a person should take steps to raise his/her score if it's below 700, particularly before applying for a mortgage, buying a car or applying for a credit card. A score below 620 suggests that person in not a good risk and can expect to be denied credit or be considered only for subprime interest rates.

The FICO score can range from 300 to 850, although very few reach 850. A person generally has to pay to get a credit score. He/she is legally entitled to one free credit report each year from each of the three credit reporting agencies. A report should be obtained from a different bureau every four months. A score can be kept high by not applying for multiple credit cards. A credit inquiry can deduct five points from the credit score. However, multiple checks made when you're shopping for a mortgage will count as only one. Asking for a personal report won't hurt the score. Neither will requests made by credit card companies that offer preapproved cards, or requests by prospective employers. Avoid applying for credit cards from companies that don't set a spending limit or won't report the borrower's limit to the credit bureaus. Cancelling multiple credit cards can suddenly lower a borrower's available credit and can hurt his/her credit score. Keeping old accounts open to ensure a long credit history can raise a score. The percentage of available credit that is used should be limited to no more than 30%, even if the balance due is paid each month. If a borrower doesn't have a credit history, one should be started by obtaining a secured credit card.

The best way to raise a credit score is to pay all obligations on time. The payment history is 35% of the credit score. One late payment reported to a credit bureau can drop a score by 100 points, particularly if the score is high. Late payments can remain on the credit report for seven years. Bankruptcies can remain for 10 years. Consulting a credit counseling service to manage excessive debt will not damage a credit score.

If a borrower's FICO score is on the low side, he/she will pay a higher interest rate on loans and credit cards. To get the best interest rates, the score should be 720 or above.

The best way to improve a credit score is to pay all bills on time. The most important item is the mortgage. Make sure it is paid on time every month. A fixed amount that is borrowed to buy new furniture or appliances is given more weight than credit cards. Keeping borrowing well below the credit limits, because the FICO score will be lower if the borrower is maxed out on credit cards. Don't have more than two or three credit cards because a large number of credit cards also lowers the FICO score. Don't apply for several credit cards at one time; it makes lenders nervous and can lower the FICO score. Other factors also affect the score, such as home ownership, which raises it, and moving frequently, which lowers it.

Having a good FICO score is very important if a borrower wants to get approved for fair interest rates on loans, credit cards, and other sources of credit.

If the FICO score isn't quite as high as the borrower would like it to be or if the borrower has no credit, listed below here are some ways that the borrower can use to raise his/her FICO score

Establish New Accounts

If a borrower wants to establish credit or raise the FICO score, get a credit card in his/her name and use it responsibly. This means charging regularly and paying the balances off regularly. If possible, get a card with a high limit and always keep the card balance below 25 percent.

Piggyback on Another Account

If a parent or some other responsible individual is willing to add the borrower's name to their credit card account, it will help the borrower's credit and boost the FICO score. Every time the parent charges and makes payments on the account it will look good for the new borrower.

Get Secured Debt

If you are having difficulty getting approved for a regular credit card, try getting a secured credit card. These cards are perfect for those who have poor credit because they allow you to make charges that can be covered by money you have already applied to an account. There is no way for you to overcharge or miss payments. Eventually, use of the card will increase your FICO score.

Don't Apply for Too Much Credit

If you have a flurry of credit inquiries on your credit history because you applied for 10 different credit cards and 5 different loans in a three-month period, it can lower your FICO score.

Increase Your Current Card Limits

The lower your balances are on your credit cards in comparison to the limit of your credit cards, the better your credit report will look and the higher your FICO score will be. If getting the balances paid down is proving to be a problem, or even if it's not, contact your creditors and ask for a higher limit.

Pay Off Old Accounts

If you have old, unpaid debts on your credit report, it can really drag your FICO score down. One of the best ways to undo the damage that has been done is to pay off old accounts and make arrangements with the creditors to have the judgments removed.

Don't Close Old Accounts

Even if they are unused, old accounts attribute to your length of credit history and affect your score. The longer you have an account, the better it looks. Closing old accounts can lower your FICO score even further.

Always Pay Bills On Time

Not paying your bills on time is a sure-fire way to lower your FICO score. Each late payment can lower your score by as much as 20 points. In contrast, paying your bills on time consistently can raise your FICO score.

Lower Your Debt

Having a significant amount of outstanding debt, such as student loans, cars loans, and other types of installment loans can lower your debt-to-income ratio and in turn, your FICO score. If you can lower your debt; your FICO score will begin to rise at a fast pace.

Get Help

If you are having a hard time managing your credit and raising your FICO score to an acceptable level, consider getting professional help through a low cost or no cost credit counseling service.

FICO scores evaluate a borrower's revolving accounts in a variety of ways, including comparing the borrower's balance to his/her available credit, as well as looking at the number of accounts with a balance. Generally, carrying lower balances on a borrower's revolving credit will increase the score. A high balance increase on a borrower's revolving credit accounts will increase the borrower's score if the borrower currently has a low or medium balance. If he/she is currently carrying high balances, the impact will probably be minimal.

Carrying very high balances on all revolving accounts will have a negative impact on a FICO score. Seeking and obtaining new credit is considered more risky when compared to consumers who don't. A sudden increase of new credit in a short period of time can cause a large drop in the score.

Many consumers will take advantage of credit offers with lower interest rates and will transfer balances between accounts in order to benefit from these lower rates. Depend on the borrower's current profile, this may result in lowering the borrower's score.

While there have been shown and described and pointed out the fundamental novel features of the invention as applied to the preferred embodiments, it will be understood that various omissions and substitutions and changes of the form and details of the apparatus illustrated and in the operation may be done by those skilled in the art, without departing from the spirit of the invention.

What is claimed is:

1. A method for teaching how a borrower's FICO credit score may increase or decrease as one or more categories of information is changed, where the significance of modifying any one category by a borrower depends on other categories of information in the credit report that make up the score and how a change in any one category has an affect on an increase or decrease of a credit score, said categories comprise bills; balances; debt; credit history; new credit accounts; credit file; unused credit cards; new credit cards; new accounts; and rate shopping, the method comprising the steps of influencing the score to increase by paying bills on time.

2. The method of claim 1 further comprising the step of: influencing the score to increase by paying bills on time without an interruption.

3. The method of claim 1 further comprising the step of: influencing the score to decrease by not paying bills on time.

4. The method of claim 1 further comprising the step of: influencing the score to increase by keeping balances low on credit cards and other revolving credit

5. The method of claim 1 further comprising the step of: influencing the score to decrease by keeping balances high on credit cards and other revolving credit

6. The method of claim 1 further comprising the step of: influencing the score to increase by paying off debt.

7. The method of claim 1 further comprising the step of: influencing the score to decrease by moving debt from one credit card to another.

8. The method of claim 1 further comprising the step of: influencing the score to remain constant by re-establishing credit history when the borrower is faced with a problem.

9. The method of claim 1 further comprising the step of: influencing the score to decrease by not re-establishing credit history when the borrower is faced with a problem.

10. The method of claim 1 further comprising the step of: influencing the score to increase by opening new credit accounts and paying them off on time.

11. The method of claim 1 further comprising the step of: influencing the score to decrease by opening new credit accounts and not paying them off on time.

12. The method of claim 1 further comprising the step of: influencing the score to increase by ordering a credit file directly from the credit reporting agency.

13. The method of claim 1 further comprising the step of: influencing the score to decrease by not ordering a credit file directly from the credit reporting agency.

14. The method of claim 1 further comprising the step of: influencing the score to increase by not closing an unused credit card.

15. The method of claim 1 further comprising the step of: influencing the score to decrease by closing an unused credit card.

16. The method of claim 1 further comprising the step of: influencing the score to increase by not obtaining new accounts that are not needed just to increase the available credit.

17. The method of claim 1 further comprising the step of: influencing the score to decrease by obtaining new accounts that are not needed just to increase the available credit.

18. The method of claim 1 further comprising the step of: influencing the score to remain constant by not closing an unused credit card.

19. The method of claim 1 further comprising the step of: influencing the score to increase by not opening a number of new accounts in a short period of time.

20. The method of claim 1 further comprising the step of: influencing the score to decrease by not opening a number of new accounts in a short period of time.
